(19) United States
(12) Patent Application Publication
(10) Pub. No.: US 2010/0065512 A1
(43) Pub. Date: Mar. 18, 2010

(54) Continuous Flow Reactor

(75) Inventor: Hans Rene Bjorsvik, BERGEN (NO)

Correspondence Address: Christopher Aniedobe;Dobe Law Group, 7207 Hanover Pkwy Ste. C/D, Greenbelt, MD, 20770, US

(73) Assignee: FLUENS SYNTHESIS AS, BERGEN (NO)

(21) Appl. No.: 12/085,032

(22) PCT Filed: Nov. 17, 2006
(86) PCT No.: PCT/NO2006/000422

§ 371 Date: Jul. 21, 2009

(30) Foreign Application Priority Data
Nov. 17, 2005 (NO) 20055456

(51) Int. Cl. B01J 19/18; B01F 3/00; B01F 11/00

(52) U.S. Cl. 210/766; 422/225; 422/205; 422/194; 210/749

(57) ABSTRACT

A reactor is described for conversion of chemical reactants comprising an oscillator with a number of perforated discs. The reactor is also suited to continuous conversion of reactants, and a method for such conversion is also described.

The present invention relates to a reactor comprising at least one chamber, and where the chamber is fitted with a number of inlets and a number of outlets for supply of reactants and outflow of products, respectively, and where an oscillator is arranged in the longitudinal direction of the chamber, so that an annular reaction room is created for conversion of chemical reactants, between the outer surface of the oscillator and the internal surface of the chamber, and where a number of discs with perforations are arranged mutually spaced apart on the oscillator, and where the oscillator is in connection to a motor that forces, in relation to the at least one chamber, a pulsating forward and backward movement of the oscillator. The present invention also relates to a method for continuous conversion of reactants.

When one carries out different chemical reactions, it is necessary to bring together different reactants to obtain a new compound. The different reactants are often dissolved in different solvents. Therefore, when a chemical reaction shall be carried out, it is particularly important to establish a good and effective contact between the reactants in the solution, and efficient mixing of the different solutions and reactants in a reaction chamber is therefore essential. Thus, it is an aim of the present invention to provide a reactor where very good mixing and contact between the reactants that are fed into the reactor is achieved.

Today, most industrial processes are carried out as so called batch processes, i.e. one carries out a reaction in a reactor/container, and when the reaction is complete the final product is transferred from the reaction to a new reactor to start a new reaction.

This is a costly method, and it has also essential disadvantages, for example, in connection with scale-up to industrial scale. It is therefore an aim of the present invention to provide a reactor where chemical processes can be driven continuously and thereby without a need for scale-up, as industrial scale production will take place with many reactors in parallel.

In this connection continuous means that one can both run a one-stage chemical reactor continuously, i.e. that a desired product is continuously taken out from the reactor at the same time as new reactants are fed into the reactor, but also that one can run a multi-stage reaction in the reactor in that one or more final products from the first reaction is led further in the reactor for a second or more subsequent reaction steps.

From the literature, different reactors are known where one can carry out extractions. U.S. Pat. No. 3,583,856 describes a device for placing two fluids in connection with each other that encompasses an extended reaction container where inlets and outlets for fluid are arranged at the top and bottom, respectively, and where a shaft goes through the device and where at least two discs with perforations of different sizes are arranged on this. The apparatus is constructed to be able to extract a chemical compound from a fluid over into another fluid phase.

DE 1,221,721 describes a device for mixing two fluids of different densities. Here a cylindrical reactor is also used, fitted with two sets of discs, where the discs in each of the sets are connected to each other so that two pair of discs can be moved axially in relation to each other. In addition, the two rods to which the discs are fitted can be moved forward and backward in the longitudinal direction of the reactor.

Furthermore, WO01/91897 describes a reactor for manufacture of polymers, especially for manufacture of polyurethane pre-polymers. Here, the reactants are mixed before they are fed through the reactor. The reactor is equipped with a set of fixed dishes with perforations, a pulse generating device is arranged upstream of the reactor to effect pulsing of the content of the reactor.

However, none of these apparatuses can be used in an appropriate way to carry out a continuous chemical reaction, and the present invention thus aims to provide an improved reactor for this purpose.

To obtain an effective chemical reaction, it is essential to achieve good contact between the different reactants that are in the solution. Normally, this is achieved in that the mixture of the different fluids is stirred, for example with a rod stirrer or magnetic stirrer.

To achieve good mixing in the reactor according to the invention, it is fitted with an oscillator that moves forward and backward in the longitudinal direction of the reactor. The oscillator pulsates with a given amplitude, which the user himself can set at a desired length. A large number of perforated discs are fitted on the oscillator. One or more pumps feed the reactants through the reactor, and the reactants will thereby be forced at great speed through the small perforations in the discs. When the reactants have passed the perforations, they enter into an area with a bigger diameter, and thereby an area where the flow velocity is smaller. In this area vortex movements that lead to very good mixing of the different reactants will therefore be created.

Furthermore, the reactor is constructed such that the reactants/chemicals can be fed in at different levels in the reactor, and the reactor is further fitted with outlets at different levels so that the final products or intermediate products can be taken out, or samples can be taken for the control of the composition of the reaction mixture.

It is known that different chemical reactions are effective only within certain temperature ranges, and the reactor is therefore surrounded by a coat in which heating fluid or cooling fluid is fed, so that the chemical reaction that is carried out can take place at a predetermined temperature. The cooling/heating coat is sectioned so that several different temperatures can be used at the same time. This will be of great significance for complex reactions, i.e. synthesis processes that are composed of several reactions, and which can be carried out successively after each other in the reactor.

The reactor, according to the invention, is thus characterised in that the ratio between “the area of the internal surface of the chamber (A)” and “the volume of the annular reaction room (V)” is in the range 1.5-33 cm²/cm³. Further embodiments of the invention are described in the subclaims 2-20.

The present invention also relates to a method for continuous conversion of reactants characterised in that the conversion takes place in a reactor which encompasses an annular reaction room for supply and removal of reactants, and where the reactants are fed from the one end of the annular reaction room to the other, and thus are forced through the perforations in a number of discs arranged on an oscillator set up so that good mixing is achieved, and where the ratio between “the area of the internal surface of the reaction room” and “the volume of the annular reaction room” is in the range 5-20 cm²/cm³, preferably about 10 cm²/cm³. Further embodiments of the method according to the invention are described in the subclaim 22.

The present invention will now be explained in more detail with reference to the enclosed figures, in which:

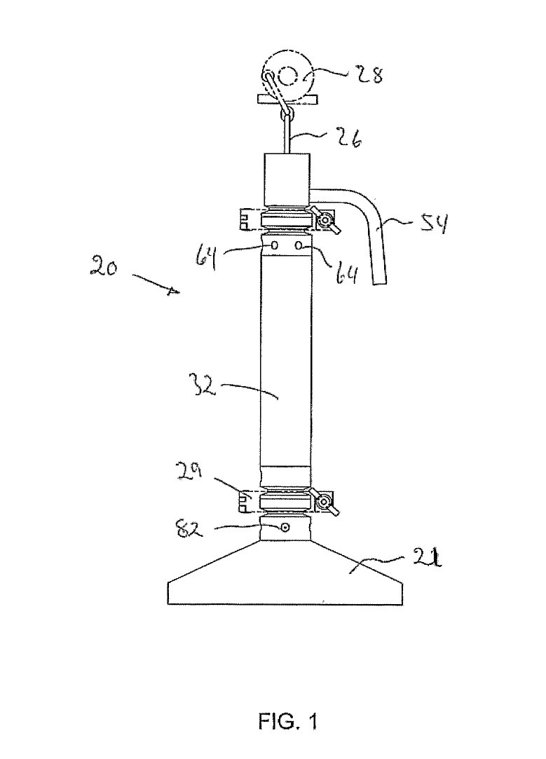

FIG. 1 shows a drawing of an embodiment example of a reactor according to the present invention,

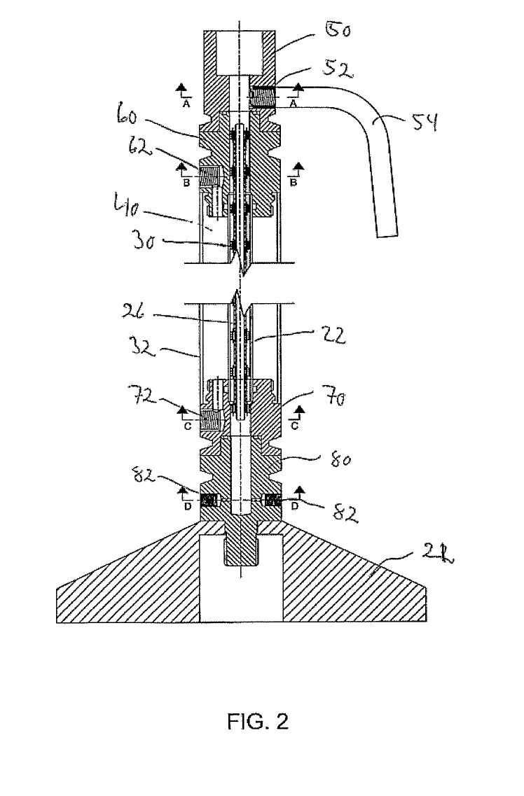

FIG. 2 shows a longitudinal section of a variant of a reactor according to the present invention,

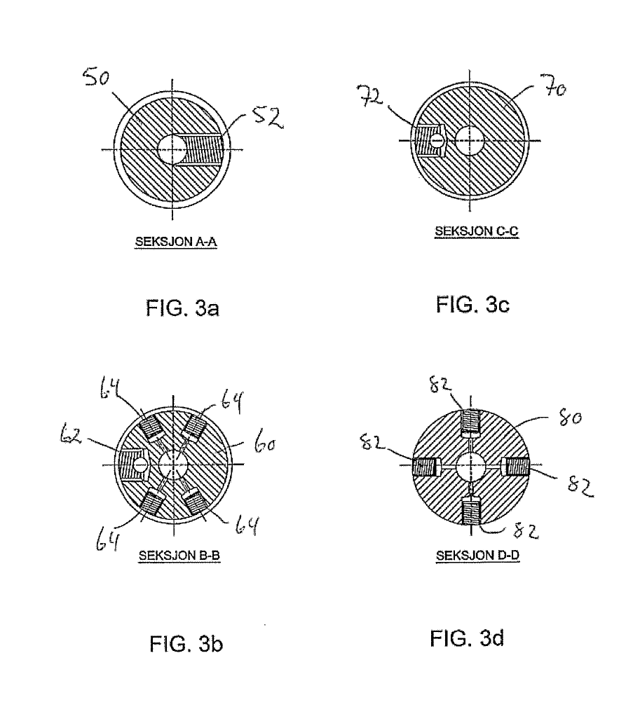

The FIGS. 3a, 3b, 3c, 3d show respective cross sections along the lines A-A, B-B, C-C and D-D of the reactor shown in FIG. 2.

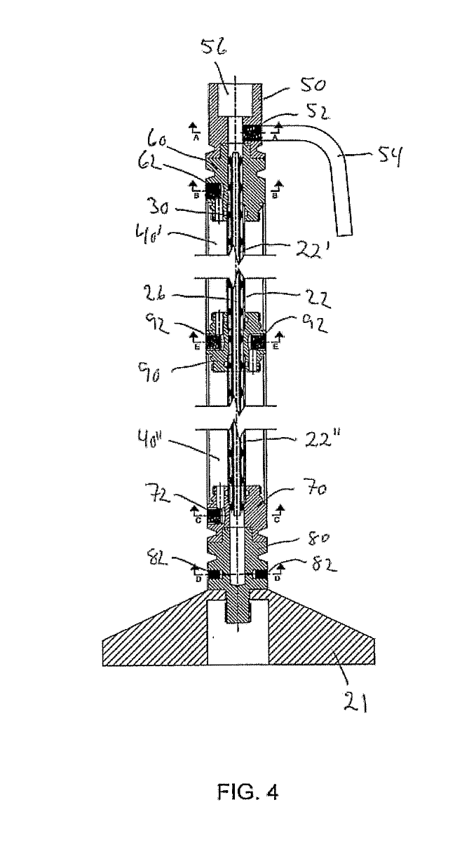

FIG. 4 shows a longitudinal section of a further variant of a reactor according to the present invention.

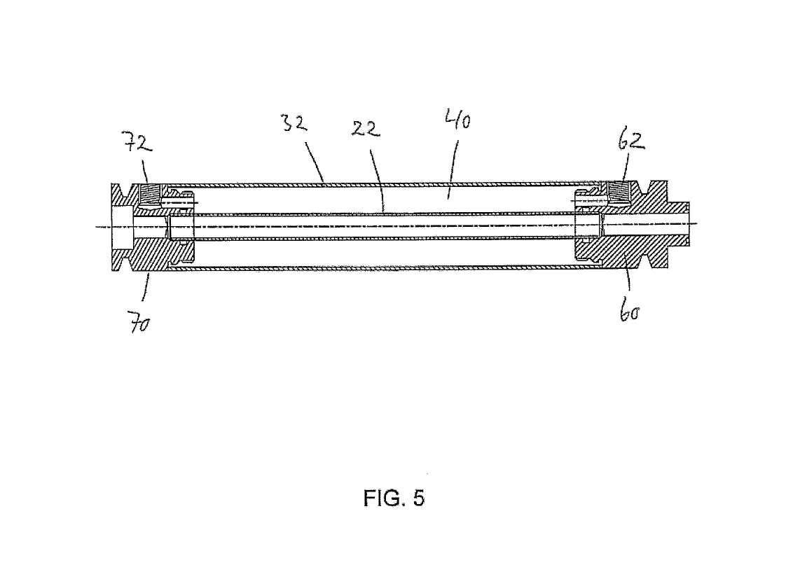

FIG. 5 shows a longitudinal section of an internal chamber surrounded by an outer coat, according to the invention.

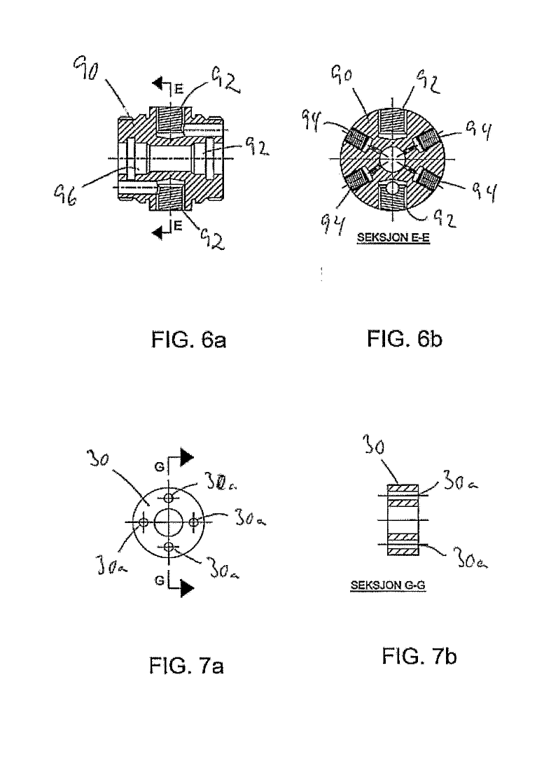

FIG. 6a shows a longitudinal section of an example of an in-between lying section for use in a reactor according to the invention.

FIG. 6b shows a cross section along the line E-E in FIG. 6a.

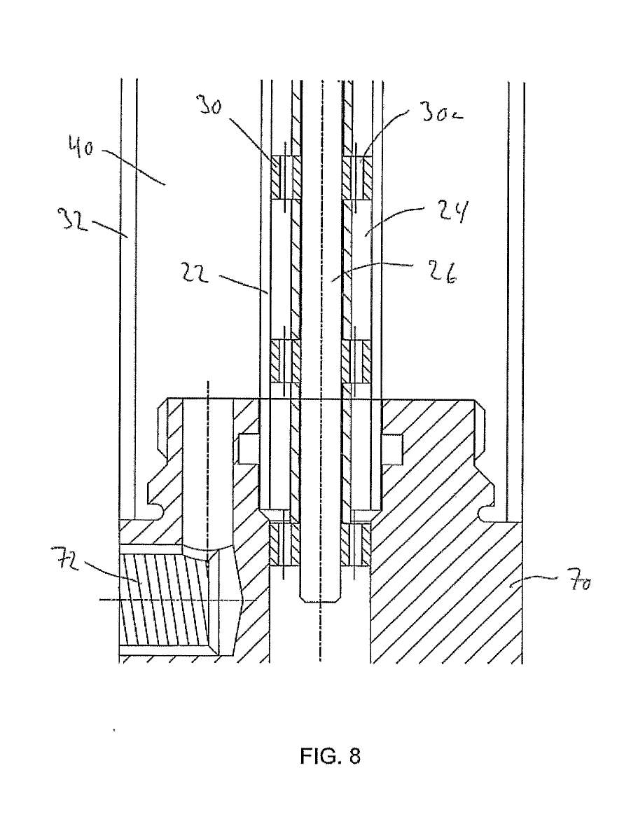

The FIGS. 7a and 7b show examples of a disc with perforations for use with an oscillator according to the invention.

FIG. 8 shows an enlarged part section of a lower part of a reactor as shown in FIGS. 2 and 4.

The characteristics and functions in connection with the application areas of the reactor shall be explained in more detail later in the description. Firstly, the construction of the embodiment examples of a reactor according to the invention shall be explained in more detail.

FIG. 1 shows a reactor 20 that is composed of several part components, where at least some of the components can be joined together with the help of one or more fastening connections, such as for example, a clamp connection 29. The different part components, or sections, encompass correspondingly shaped jointing parts so that the reactor can be put together with as many sections as is desirable. To drive an oscillator 26 in the reactor, a motor 28 or the like is arranged in the reactor adjoining the oscillator 26, where the oscillator 26, in connection with the motor 28, forces, in relation to at least one reactor chamber 22 in the reactor, a pulsating forward and backward movement of the oscillator 26. The motor 28 preferably has a speed regulator and the motor 28 is controlled so that the oscillator 26 pulsates at a predetermined and controllable amplitude and frequency. The reactor can also comprise a lower support foot 21, and also an upper product outlet pipe 54. Furthermore, the reactor 20 comprises externally a number of communication openings 64, 82 in the form of inlets and outlets for supply of reactants and outflow of products, respectively. The different fluids are fed into the reactor via the inlets and pumped through the reactor until they finally are led out through the outlets arranged preferably in the upper section of the reactor at the product outlet pipe 54.

In a preferred embodiment, the reactor can have a length in the area 5-300 cm, more preferably 50-200 cm, most preferably 80-150 cm, and the flow of fluid through the reactor can be 0.1-1000 ml/min.

Via a number of controlled pumps (not shown in detail in the figures), different fluids are fed into the reactor 20. The reactor 20 can be of any shape imaginable, but a preferred embodiment of the reactor has a cylindrical shape as shown in the figures. The diameter and length of the reactor can also be varied. One or more chemical compounds/reactants can be dissolved in separate solvents, or there can be one or several compounds in liquid phase, and the different fluids can be fed into the reactor with different fluid flow velocities controlled by the different pumps. The reactor can function in any position, but it is generally preferred that the reactor is arranged vertically, and that the different fluids are fed into the bottom section of the reactor, and that they are thus pumped against gravitational forces through the reactor, and that intermediate products or final products are led out at a higher level in the reactor.

The oscillator 26 is preferably shaped as a rod or strut comprising a number of ring-formed, external discs 30 arranged mutually spaced apart in the longitudinal direction of the oscillator, where the oscillator with the discs is inserted with a close fit in at least one chamber 22 of the reactor so that an annular reaction room 24 for conversion of chemical reactants is formed in the reactor, between the outer surface of the oscillator 26 and the internal surface 22 of the chamber. Said ring-formed discs 30 are fitted with a number of perforations 30a to permit through flow of fluid, and to contribute to the mixing of fluid in the chamber 22. When the oscillator is moved upward and downward, the fluids in the reactor 20 will be forced through the perforations 30a in the discs 30. It is this forcing of fluid through small perforations 30a that increases the through-flow velocity of the fluid for the different molecules in the fluid. The number of discs 30 in the reactor 20, and the number of perforations 30a, and the diameter of the perforations 30a will be decided according to the reaction that is carried out in the reactor 20. Typically, one will prefer a large number of discs, and also many small perforations.

The discs 30 can have a mutual centre-to-centre distance in the area 0.2 cm-3.0 cm, more preferably in the area 0.8-1.4 cm, and most preferably about 1 cm. Each disc 30 can be fitted with 1-10 perforations 30a, preferably 2-6 perforations, more preferably 3-5 perforations, and most preferably 4 perforations. Furthermore, each perforation 30a can have a diameter in the area 0.2-3 mm, more preferably in the area 0.5-2 mm, and most preferably about 1.25 mm.

The ratio between the area of the internal surface of the chamber 22 and the volume of the annular reaction room 24 can, for example, be in the area 1.5-35 cm²/cm³. Furthermore, the ratio between the area of the internal surface of the chamber 22 and the volume of the annular reaction room 24 can be more specifically in the area 5-20 cm²/cm³. Alternatively the ratio between the area of the internal surface of the chamber 22 and the volume of the annular reaction room 24 can be about 10 cm²/cm³.

One of the issues that separate the present invention from previously known reactors is the ratio between “the volume that is available for chemical reaction” and “the contact surface that is available for contact between reactants/solvents and the heating/cooling medium”. The reactor according to the present invention provides such a ratio between the heating/cooling surface and reaction volume that has not been previously available.

For exothermal reactions, this ratio between cooling surface and reaction volume ensures that the reactants in the chemical processes can be much more concentrated, i.e. that the amount of dissolution means or solvent can be reduced considerably. This provides an essential advantage compared with known reactors.

This ratio between surface and volume is realised in the embodiment of the reactor shown as the ratio between “the area of the internal surface of the chamber 22” and the “volume of the annular reaction room 24”.

Furthermore, the reactor 20 can be surrounded by a coat 32 so that an annular room 40 is formed about said at least one chamber 22. A heating or cooling fluid is fed into the coat 32 so that one can carry out the chemical reactions at a desired is temperature. The heating or cooling fluid is fed through inlets 72 and out through outlets 62. Inlets and outlets can be arranged at several different levels in relation to the longitudinal direction of the reactor 20 so that the heating or cooling fluid can be supplied and taken out at different locations on the reactor. At a favourably controlled supply and removal of heating or cooling fluid one will achieve a good control of the temperature in the whole of the reactor, even with strongly exothermic and endothermic reactions, and one can also divide the reactor into different temperature zones.

Each of the inlets and outlets can be fitted with valves (not shown) and opening/closure of these can be controlled automatically via a PLS or similar digital control. Furthermore, the flow of fluid through one part of, or all the inlets and outlets can be regulated by pumps. The whole arrangement can be controlled by a computer equipped with the necessary hardware and software so that the functionality of the reactor is adjusted or optimised to a given chemical reaction.

With appropriate control of the different pumps and valves, one will be able to feed a number of different fluids containing chemical compounds into the chamber at the levels one should wish. One adjusts the through-flow velocity of the fluid to the reaction time so that one can take out either intermediate products or final products at a given level in the reactor 20. Furthermore, one can monitor the whole process in that one can take samples of the reaction mixture at different levels in the reactor. This can also be done online in that one establishes a loop from an outlet to an inlet, and where the measuring instrument is arranged in this loop. Furthermore, one can carry out the chemical reaction at the temperature one should wish by using different heating or cooling fluids in the coat 32. The through-flow velocity of this medium can be regulated and also at which level(s) the medium is fed in and taken out.

Most of the explanation above is an example of a one step process, but as mentioned, the reactor can also be used to run several processes stepwise after each other.

The reactor is preferably put together in stages by a number of sections, for example, as shown in FIG. 2 with the sections 50, 60, 70, 80, or as shown in FIG. 4 with the addition of an in-between lying section 90 so that the annular room 40 of the reactor is divided into a number of chambers 40′,40″, each surrounding associated chambers 22′,22″. The annular reaction room can be connected to several chambers so that different temperature zones can be established in the annular reaction room. The in-between lying section 90 can be arranged between each chamber and comprises inlets and outlets 92, 94 for said reactants and heating or cooling fluids, respectively, for control of each chamber separately. Said inlets/outlets 92, 94 are set up for supply and removal of heating or cooling medium to and from the above lying chamber 40″ and the below lying chamber 40′, respectively, via associated outlets and inlets in said chambers 40′, 40″. The in-between lying section 90 comprises a through bore with the same internal diameter as the internal diameter of said reaction chamber 22, in which a seat 96 is provided at each end of the bore to receive a respective reaction chamber 22.

The oscillator 26 can move, for example, with a frequency of 0.0-10 Hz, preferably 2.0-4 Hz and the oscillator 26 can move, for example, with an amplitude of 0.1-5 cm, more preferably with an amplitude of 0.5-1.5 cm.

It shall be pointed out that some chemical processes can be carried out without the oscillator 26 moving, as the through-flow of fluid which is brought about by the pumps is sufficient to achieve adequate mixing for conversion of reactants. However, tests with the reactor according to the invention show that the rate of reaction and the yield will normally increase if the oscillator oscillates.

The ratio between “the area of the internal surface of the chamber 22” and “the volume of the annular reaction room 24” is provided in that the strut of the oscillator 26, for example, has a diameter in the area 0.2-2.4 cm, more preferably 0.7-1.4 cm and most preferably about 0.6 cm, while the inner diameter of the chamber 22 is in the area 0.5-2.5 cm, more preferably 0.8-1.5 cm, most preferably about 1.0 cm, respectively.

The volume available for reaction will decrease if the distance between the discs is reduced, or if the diameter of the strut of the oscillator 26 increases, given the same length of the reactor.

In the chemical industry much prototype testing takes place, and scaling up is often very unpredictable and very expensive. With the system which is described above, one can test a reactor in the laboratory, establish the different process parameters and programme the control of the process, and when the process functions satisfactorily, one can simply transfer it to the production scale by connecting several reactors in parallel.

For a conventional chemical synthesis (reduction of cyclohexanone to cyclohexanol), we have shown that a reactor with a diameter of 10 mm and a length of 1.0 m can produce ˜350 grams per hour. For 24 hour continuous operation the reactor can produce 8.4 kg, and 58.8 kg in the course of one week, and 3066 kg during one year. With the help of 17 reactors connected in parallel, 50 tonnes can be produced during one year, which corresponds to a large volume of fine chemical. The size of the reactor will therefore not be any limitation for the production of the chemical.

Furthermore, it is a great advantage that traditional batch processes can simply be replaced with a continuous chemical process carried out in the reactor according to the invention without large development work of the subsequent processing steps with regard to isolation and purification of the finished product.

to Table 1 below shows a comparison with known devices for chemical processes, and attention is given to the ratio between reaction volume (V) and the fluid contact area (A) for cooling or heating.

| Type of reactor | Size | | A/V (cm²cm⁻³) |
|---|---|---|---|
| Flat micro channel | 100 | mm | 200 |
| Laboratory flask | 100 | ml | 1 |
| Tank reactor | 50 | gallons | 0.084 |
| Tank reactor | 1 | m³ | 0.060 |
| An embodiment of a reactor | 38 | ml | 10 |
| According to the invention | | | |

In the experimental part given below, a number of examples are given which show how efficient the reactor is for running a number of well-known chemical reactions.

### EXAMPLE 1

### Effect of Oscillator

### 1A) Reduction of Cyclohexanone to Cyclohexanol

37.0 g of cyclohexanone (MW 98.15, 376 mmol) have been diluted to 200 ml with ethanol in a graduated flask and connected to the pump 1 working at 8.55 rpm. 14.2 g of sodium borohydride (MW 37.83, 376 mmol) have been dissolved in a mixture of ethanol (180 ml) and water (20 ml) and connected to the pump 2, working at 8.55 rpm.

The two reagent solutions have been pumped into the reactor being the oscillator in the ‘on’ position. The residence time (RT) was 28 minutes. The reaction is temperature was room temperature.

The collection of the resulting reaction mixture has been performed in the following way:

| | |
|---|---|
| I Phase: | Collection 1 |
| Oscillator: | on |
| Total pumping speed: | 1.36 ml/min (=v₁ + v₂ = V reactor/RT, |
| | 38 ml/28 min) |
| Collection time: | 1 hour |
| II Phase: | Equilibrating phase |
| Oscillator: | off |
| Total pumping speed: | 1.36 ml/min |
| Discharge time: | 30 min. |
| III Phase: | Collection 2 |
| Oscillator: | off |
| Total pumping speed: | 1.36 ml/min |
| Collection time: | 1 hour |

### Work-Up for Phases I and III

The collected phase has been diluted with H₂O and quenched with acetic acid 99% at about 5° C. The aqueous/ethanol phase has been extracted with chloroform. The organic phase was dried, evaporated at reduced atmosphere and distilled under reduced pressure giving pure cyclohexanol (b.p. 75° C. at 20 mmHg).

### Results:

| Phase 1: | oscillator ‘on’: | Cyclohexanol expected 7.3 g, isolated 7.0 g, |
|---|---|---|
| | | 96% |
| Phase 2: | oscillator ‘off’: | Cyclohexanol expected 7.3 g, isolated 2.6 g, |
| | | 36% |

### Remarks:

The reaction conducted without oscillation gives a substantially lower yield compared to when the oscillator is on. During the reduction reaction a certain pressure is created due to the development of hydrogen gas. There is more gas dispersion when the oscillator is in the ‘on’ position. When the oscillator is in the ‘off’ position the gas is not dispersed and it blocks the NaBH₄ solution pumping determining a worst yield.

### 1B) Acetylation of Aniline

51.1 g of aniline (MW 93.13, d 1.022, 549 mmol) is dissolved in 120 ml of acetic acid and connected to pump 1 working at 4.36 rpm. The acetic anhydride (150 ml) and the acetic acid (20 ml) are mixed together and connected to pump 2, working at 7.36 rpm. The two reagent solutions have been pumped into the reactor being the oscillator in the ‘on’ position. The residence time (RT) was 40 minutes. The reaction temperature was 50° C.

The collection of the resulting reaction mixture has been performed in the following way:

| | |
|---|---|
| I Phase: | Collection 1 |
| Oscillator: | on |
| Total pumping speed: | 0.48 ml/min (=v₁ + v₂ = V reactor/RT, |
| | 38 ml/40 min) |
| Collection time: | 40 min |
| II Phase: | Equilibrating phase |
| Oscillator: | off |
| Total pumping speed: | 0.48 ml/min |
| Discharge time: | 40 min. |
| III Phase: | Collection 2 |
| Oscillator: | off |
| Total pumping speed: | 0.48 ml/min |
| Collection time: | 40 min |

### Work-Up for Phases I and III

The reaction mixture is diluted with water (100 ml) and cooled at 4 C overnight to help the precipitation of the acetanilide as ivory coloured crystals.

### Results:

| | | |
|---|---|---|
| Phase 1: | oscillator ‘on’: | Acetanilide expected 8.3 g, isolated 4.8 g, |
| | | 58%¹ |
| Phase 2: | oscillator ‘off’: | Acetanilide expected 8.3 g, isolated 0 g, 0% |

### Remarks:

The reaction conducted without oscillation gives no precipitation of the product after water addition. Some crystals precipitate from the reaction mixture of the collection 2 after 15 days in the refrigerator.

### EXAMPLE 2

### Paal-Knorr Condensation

Pyrrole derivatives find application in the pharmacological industry for the treatment of rhinitis and some of them have shown good bacteriostatic activity². They are also used as biological probes, molecular receptors for anions and cations, as dyes (including fluorescent dyes), charge transfer agents, conductive materials, polymers³ and polymer additives, non-linear optical materials, and electroluminescent devices.

One method to synthesise pyrroles is based on the condensation of a 1,4-dicarbonyl compound with an excess of a primary amine or ammonia. The reaction is influenced by pH condition, so that addition of acetic acid can accelerate the is reaction but the use of amine/ammonium hydrochloride salts give formation of furans. According to Amarath² the formation of an imine during the reaction has to be excluded. It was proved experimentally that the reaction goes through the cyclisation of a hemiacetal, followed by several de-hydration step.

### Synthesis of b-(2,5-dimethyl-1-pyrryl)ethanol

Batch procedure⁴

To 5.4 g (MW 61.08, 88.0 mmol, r 1.012, V=5.3 ml) of b-aminoethanol, 10.0 g of acetonylacetone (MW 114.14, 88.0 mmol, r 0.973, V=10.3 ml) is dropped rapidly. The reaction is exothermic and is run at room temperature overnight. The mixture is then distilled under vacuum (P=1 mm Hg). The oil bath is maintained at 40° C. in the beginning in order to remove all of the water formed during the condensation reaction. The product distilled at 84° C. as uncoloured oil, which solidifies at room temperature. Isolated pure product 9.0 g (MW 138.19, 65.1 mmol), 74.0% yield.

### Reactor According to the Invention Operating in Continuous Flow:

52.0 g of b-aminoethanol and 97.3 g of acetonylacetone were pumped in the reactor with pump 1 working at 8.78 rpm and pump 2 working at 17.56 rpm respectively. The reaction was run at room temperature and the residence time was 18 minutes having a total speed of 2.1 ml/min (38 ml/18 min). The isolated yield was around 100%.

### EXAMPLE 3

### The Haloform Reaction

The haloform reaction¹ provides carboxylic acid from methylketones in basic media. The reaction operates on methylarylketones that in the first step is trihalogenated using bromine, chlorine, or iodine. In the next step, the trihalo ketone is attacked by hydroxide ion, to provide the haloform CHX₃ (X═Cl, Br, I) and the corresponding carboxylic acid of the methylarylketone. The reaction finds application in organic synthetic for the oxidation of methylarylketones to carboxylic acids.

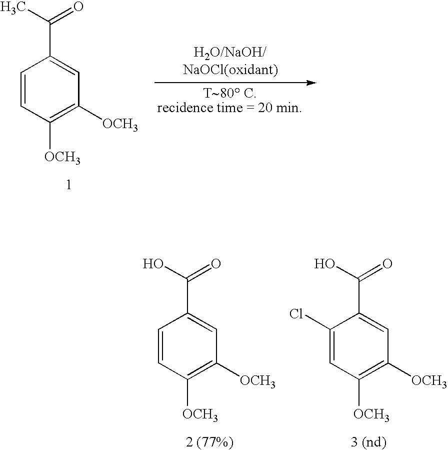

Studies on the improvements and optimization of a process to veratric acid using the haloform reaction with acetovanillione 1 as substrate is previously disclosed.ⁱⁱ The batch process that was thoroughly optimized furnished 91% of the desired oxidation product 2 with a reaction time of 2 h. The by-product 3 was not detected.

The experimental runs performed with a reactor according to the present invention were conducted with the same optimised reaction conditions as in the batch reactor. The experiments revealed the reaction to be significant faster in the reactor according to the invention compared to the reactions performed in batch. A yield of 77% of veratric acid 2 was achieved using a reactor residence time of only 20 min. The chlorinated derivative 3 was not detected.

### EXAMPLE 4

### Nef Reaction

The Nef reaction is one of the most important synthetic transformations of nitro compounds. The Nef reaction involves the formation of an alkaline nitronate from a primary or secondary aliphatic nitro compound, which quickly is solvolysed in aqueous or methanolic acid solution to the corresponding aldehydes and ketones (Nef, J. U. Ann. 1894, 280, 263).

The literature covers a long list procedures that have been described as alternatives for the cleavage of the carbon-nitrogen bond under milder conditions. Hydrolysis of the double bond C═N of the nitronates can be performed by oxidative cleavage by means of KMnO₄, ozone, meta-chloroperbenzoic acid, dimethyl-dioxirane, and many more. Ballini et al. reported a selective Nef reaction of secondary nitroalkanes under very mild conditions by using 1,8-diazabicyclo[5.5.0]undec-7-ene (DBU) as tertiary amidine base.

With the reactor according to the present invention we have used the original protocol of Nef reaction. First, an alkanine aqueous solution is used, then the nitronate is hydrolysed in aqueous acidic solution. Experiments were performed both in batch (round bottom flask), and by using the continuous flow reactor according to the invention.

The reactor according to the invention proceeds with a significant elevated reaction rate compared to the corresponding reaction conducted in batch, namely, 67% yield (10 min. residence time. In batch a yield of 58% (30 min.), and 72% (24 h). The reaction conditions have not been optimised.

### EXAMPLE 5

### Sodium Borohydride Reduction of Cyclohexanone

Reduction is one of the fundamental reactions in synthetic organic chemistry. NaBH₄ is an important reducing agent in the industry due to its highly chemoselectivity, stereoselectivity and cost effectiveness.

The inventors of the present invention have performed experiments with the classical reduction of cyclohexanone to the corresponding Cyclohexanol.

The sodium borohydride reduction was conducted with two various reaction media, namely ethanol/water and water. Utilizing a residence time of 15-17 min. in the reactor of the present invention, a quantitative yield were detected for the target product Cyclohexanol.

The borohydride reaction was smoothly performed receiving a quantitative yield when the continuous flow reactor according to the invention was used.

### Process Conditions & Reactor Set-Up:

Reaction temperature (at start) 20° C.
Residence time 3 min.
Flow speed piston pump-1 (NaBH₄ in H2O—0.37 g mL⁻¹) 6.4 mL min⁻¹
Flow speed piston pump-2 (cyclohexanone—neat) 6.4 mL min⁻¹
Reactor length ˜1 m
Available reactor volume ˜38 mL
Oscillator frequency ˜3 Hz
Oscillator amplitude ˜10 mm

### EXAMPLE 6

### Nucleophilic Aromatic Substitution

Generally, a nucleophilic substitution is the replacement of one group, the leaving group, by another, the nucleophilic group. It permits, for example the replacement of a halogen by groups with the nucleophile centred on oxygen, nitrogen, sulphur or another carbon.

Aromatic nucleophilic substitution occurs under rather harsh reaction conditions and the yields are poor, unless the leaving group is activated by the presence of several strong electron withdrawing groups, such as the nitros.

Palladium catalysed reactions in presence of trialkyl or triaryl phosphine and a base, represent en efficient method for the synthesis of aryl amines using the corresponding aryl chlorides, bromides or triflates.

Diaryl ethers, diaryl thioethers and diaryl amines can be achieved running the nucleophilic aromatic substitution on the aryl halides with KF-alumina and crown ethers macrocycles.

We have chosen one classical aromatic nuclephilic substitution in order to evaluate the performance of the continuous flow reactor of the present invention. 2,4-dinitrochlorobenzene was reacted with piperidine at room temperature in presence of acetonitrile as solvent.

The flow rate of the pumps was adjusted to achieve a residence time of 22 min. Measurements of the reaction mixture revealed a complete conversion, with a yield and a selectivity of ±100% of target molecule 1-(2,4-dinitrophenyl)-piperidine).

The achieved results is comparable with the reaction conducted in batch (>99%). Previously disclosed results, shows that when such a reaction is conducted with a micro-reactor system, a slightly inferior results (96%) was achieved.

### Process Conditions & Reactor Set-Up:

Reaction temperature 20° C.
Residence time 5 min.
Flow speed piston pump-1 (Ph(NO2)2Cl in CH3CN 0.8 g mL-1) 4.4 mL min-1
Flow speed piston pump-2 (piperidine—neat) 3.53 mL min-1
Reactor length ˜1 m
Available reactor volume ˜38 mL
Oscillator frequency ˜3 Hz
Oscillator amplitude ˜10 mm

1. A reactor (20) comprising at least one chamber (22), and where the chamber is connected with a number of inlets and a number of outlets for supply of reactants and removal of products, respectively, and where an oscillator (26) is arranged in the longitudinal direction of the chamber, so that an annular reaction room (24) is established for conversion of chemical reactants between the outer surface of the oscillator (26) and the internal surface of the chamber, (22), and where a number of discs (30) with perforations (30a) are arranged on the oscillator mutually spaced apart, and where the oscillator is in connection with a motor (28) that enforces a pulsating forward and backward movement of the oscillator in relation to at least one chamber (22), characterised in that the ratio between the area of the internal surface of the chamber and the volume of the annular reaction room (24) is about 1.5-35 cm²/cm³.

2. The reactor (20) according to claim 1, characterised in that the ratio between the area of the internal surface of the chamber (22) and the volume of the annular reaction room (24) is about 5-20 cm²/cm³.

3. The reactor according to claim 1, characterised in that the ratio between the area of the internal surface of the chamber (22) and the volume of the annular reaction room (24) is about 10 cm²/cm³.

4. The reactor according to claim 1, characterised in that the chamber (22) is surrounded by a coat (32) arranged to contain heating or cooling medium, in which the coat forms an annular room (40) about said at least one chamber (22) and comprises respective inlets/outlets (62, 72).

5. The reactor according to claim 4, characterised in that the chamber (40) which surrounds an annular reaction room (24) can be divided into several chambers (40) so that different temperature zones can be established for the annular reaction room (24).

6. The reactor (20) according to claim 1, characterised in that the reactor is a jointed construction comprising a number of sections (50, 60, 70, 80, 90) and the annular room (40) of the reactor is divided into a number of chambers (40′,40″), each surrounding associated chambers (22′,22″), as an in-between lying section (90) is arranged between each chamber (40′,40″,22′,22″), where the in-between lying section (90) comprises inlets and outlets (92,94) for said reactants and heating or cooling medium, respectively, for control of each chamber separately (40′,40″,22′,22″).

7. The reactor (20) according to claim 1, characterised in that the chamber (22) is divided into at least an upper and a lower chamber (22′, 22″) separated by an in-between lying section (90), where, in the lower chamber (22″) in the main are arranged entrances and inlets, and where, in the upper chamber (22′) in the main are arranged exits and outlets.

8. The reactor (20) according to claim 1, characterised in that the annular room (40) is divided into at least an upper and a lower chamber (40′, 40″) separated by an in-between lying section (90) where, in the lower chamber (40′) in the main are arranged entrances (82) and inlets (72) and where, in the upper chamber (40″) in the main are arranged exits (64) and outlets (62).

9. The reactor (20) according to claim 8, characterised in that the in-between lying section (90) comprises a through bore with the same internal diameter as the internal diameter of said reactor chamber (22), and that a seat (96) is provided at each end of the bore to receive a respective reactor chamber (22).

10. The reactor (20) according to claim 9, characterised in that the in-between lying section (90) comprises respective inlets/outlets (92) for supply and removal of heating or cooling fluid to and from the above lying chamber (40″) and the below lying chamber (40′), respectively, and also outlets (94) for said fluids.

11. The reactor (20) according to claim 1, characterised in that the oscillator (26) moves at a frequency of 0.0-10 Hz, preferably 2.0-4 Hz.

12. The reactor (20) according to claim 1, characterised in that the oscillator (26) moves with an amplitude of 0.1-5 cm, more preferably with an amplitude of 0.5-1.5 cm.

13. The reactor (20) according to claim 1, characterised in that the ratio between the area of the internal surface of the chamber (22) and the volume of the annular reaction room (24) is provided in that the strut of the oscillator (26) has a diameter in the area 0.2-2.4 cm, more preferably 0.7-1.4 cm, and most preferably about 0.6 cm, while the inner diameter of the chamber (22) is in the area 0.5-2.5 cm, more preferably 0.8-1.5 cm, most preferably about 1.0 cm, respectively.

14. The reactor (20) according to claim 1, characterised in that the oscillator (26) is fitted with a number of discs (30) with a mutual centre to centre distance in the area 0.2-3.0 cm, more preferably in the area 0.8-1.4 cm, and most preferably about 1 cm.

15. The reactor (20) according to claim 1, characterised in that each disc (30) is fitted with at least one perforation (30a).

16. The reactor (20) according to claim 1, characterised in that each disc (30) is fitted with 1-10 perforations (30a), preferably 2-6 perforations, more preferably 3-5 perforations, most preferably 4 perforations.

17. The reactor (20) according to claim 1, characterised in that each perforation (30a) has a diameter in the area 0.2-3 mm, more preferably in the area 0.5-2 mm, and most preferably about 1.25 mm.

18. The reactor (20) according to claim 1, characterised in that it has a length in the area 5-300 cm, more preferably 50-200 cm, most preferably 80-150 cm.

19. (canceled)

20. The reactor (20) according to claim 1, characterised in that the annular reaction room can be connected with several chambers so that different temperature zones can be set up in the annular reaction room.

21. A method for continuous conversion of reactants, characterised in that the conversion takes place in a reactor comprising an annular reaction room for supply and outflow of reactants, and where the reactants are fed from one end of the annular reaction room to the other, and thereby are forced through perforations in a number of discs arranged on an oscillator set up so that good mixing is obtained, and where the ratio between the area of the internal surface of the reaction room and the volume of the annular reaction room is in the area 5-20 cm²/cm³, preferably about 10 cm²/cm³.

22. The method according to claim 21, wherein the conversion takes place in a reactor further comprising a coat for heating or cooling fluid arranged externally in relation to the reaction room, set up so that good heat exchange between the annular reaction room and heating/cooling medium is obtained so that exothermic or endothermic reactions can be carried out.

23. The method of claim 21 wherein the rate of flow through of fluid in the reactor is 0.1-1000 ml/min.
